(19) United States
(12) Patent Application Publication
(10) Pub. No.: US 2025/0216275 A1
(43) Pub. Date: Jul. 3, 2025

(54) FORCE SENSOR

(71) Applicant: QUEEN MARY UNIVERSITY OF LONDON, Greater London (GB)

(72) Inventors: Lorenzo JAMONE, Greater London (GB); Pedro RIBEIRO, Greater London (GB); Augusto BONZINI, Greater London (GB); Gokhan SOLAK, Greater London (GB); Rodrigo ZENHA, Greater London (GB); Zain MURTAZA, Greater London (GB); Elif Ecem ÖZKAN, Greater London (GB); Susana Isabel Pinheiro Cardoso de FREITAS, Greater London (GB)

(21) Appl. No.: 18/850,223

(22) PCT Filed: Mar. 20, 2023
(86) PCT No.: PCT/GB2023/050686

§ 371 Date: Sep. 24, 2024

(30) Foreign Application Priority Data
Mar. 25, 2022 (GB) 2204248.5

(51) Int. Cl. G01L 1/12; G01L 5/169

(52) U.S. Cl. CPC G01L 1/122; G01L 5/169

(57) ABSTRACT

A tactile sensor, consisting of a flexible main body with embedded magnets, soft magnetized cilia on the main body, and magnetic sensing elements embedded on the substrate layer. The magnetic sensing elements produce signals in response to the changes in the magnetic field. Tactile interaction with the main body and cilia displaces the magnetic material and changes the magnetic field. Cilia are sensitive to sub-mN force magnitudes, the main body is sensitive to larger range of force magnitudes. Multiple sensing elements, magnets and cilia may be distributed over large and curved surfaces. Three-axial forces can be measured using the sensor.

### CROSS-REFERENCE TO RELATED APPLICATIONS

The present application is a national stage entry from International Application No. PCT/GB2023/050686, filed on Mar. 20, 2023, published as International Publication No. WO 2023/180716 A1 on Sep. 28, 2023, and claims priority to Great Britain Patent Application No. 2204248.5, filed Mar. 25, 2022, the disclosures of all of which are hereby incorporated by reference in their entireties.

### FIELD

The present invention relates to force sensors, in particular to force sensors that can sense contact forces.

### BACKGROUND

Applications that require interaction between physical bodies benefit from tactile contact information between these bodies. Some examples of such applications are robotic manipulation, prosthetics, and rehabilitation. The tactile information may be used to detect contact, adjust forces between physical bodies, prevent extreme collisions, or gain information about the touching bodies.

This information can be provided by tactile sensors of different kinds. Desirable characteristics of a tactile sensor include flexibility, sensitivity and manufacturing simplicity. Flexibility of a sensor is desired in many applications as it improves the safety of the sensor and the other objects in the environment, and it increases the robustness of object grasping. Sensitivity determines the range of tasks the sensor can be used in. Manufacturing simplicity allows the production of the sensor efficiently.

A tactile sensor that is flexible and easy to manufacture is described in Patent Document 1. This sensor is manufactured by embedding a magnet in flexible material and placing magnetoresistive elements and inductors at the bottom.

Another tactile sensor that achieves flexibility by putting a flexible magnetic layer on top of a non-magnetic layer and an inductive coil is described in Patent Document 2. This sensor contains a layer with low magnetic permeability to decrease the effects of magnetic noise.

Another flexible tactile sensor formed using magnetic rubber which increases conductivity under pressure is described in Patent Document 3. The magnetic rubber contains a pair of electrodes that are insulated by the rubber, and it is coated by a resin body.

A Hall-effect based compact sensor that can measure three-axial forces is described in Non-patent Document 3. The referenced sensor consists of a soft silicon body, a magnet embedded in this body, and a Hall-effect sensor. This sensor is easy to manufacture and miniaturize. The force range of this sensor is reported as approximately 10 mN-11 N. A distributed tactile sensor working with the same principle is also described in Non-patent Document 1. In this work, multiple magnets and Hall-effect sensors are distributed on a flexible printed circuit board (PCB). The sensor is then placed on a curved robot fingertip.

Another tactile sensor using hair-like cylindrical structures made of magnetized soft material and giant magnetoresistive (GMR) sensors to detect sub-mN forces is described in Non-patent Document 2. The cylindrical structures are referred to as “cilia” in this document. The cilia are manufactured by mixing NdFeB magnetic beads with polydimethylsiloxane (PDMS). The referenced work reports a minimum force of 333 μN detected.

Generally, for a flexible magnetic sensor, sensitivity to small forces is limited by the stiffness of the sensor body. The sensitivity of a flexible sensor can be increased using softer materials. However, using softer materials decreases the range of the maximum measurable force. Hence, determining the sensor body flexibility is a trade-off between sensitivity and the maximum measurable force.

### SUMMARY

An aim of the present invention is to provide a flexible tactile sensor that is sensitive to both small and large forces.

According to the present invention, there is provided a force sensor comprising:
a magnetic sensing element;
a flexible body;
a magnet connected to the flexible body; and
a plurality of flexible projections having magnetic material embedded therein attached to the flexible body.

According to the present invention there is also provided a force sensor system comprising a plurality of force sensors as described above mounted to one substrate, desirably a flexible printed circuit board.

Sensors according to embodiments of the invention can be used for a wide range of applications reliably. They can have a simple structure that is easy to manufacture. The invention combines different approaches to achieve this solution.

### BRIEF DESCRIPTION OF THE DRAWINGS

For a more complete understanding of the invention, reference is made to the following description and accompanying schematic drawings, in which:

FIGS. 1(a) and 1(b) are cross-sections of variants of a semi-spherical embodiment with different cilia types;

FIGS. 2(a) and 2(b) depict behaviour of a semi-spherical embodiment under external force applied to a point on the sensor;

FIGS. 3(a) and 3(b) are perspective views of two embodiments;

FIGS. 4(a), 4(b), and 4(c) are a cross-section and two planar views of alternative flat embodiments with different cilia topologies;

FIGS. 5(a) and 5(b) depict embodiments with multiple distributed tactile sensors on a curved surface;

FIG. 6 is a graph of mean readings of sensitivity tests for prototypes with and without cilia;

FIG. 7 is a graph of three axial (x, y, z) readings of the sensor prototype with cilia, during the sensitivity test; and

FIG. 8 is a graph of three axial (x, y, z) readings of the baseline sensor prototype without cilia, during the sensitivity test.

In the various figures, like parts have like reference numerals.

### DETAILED DESCRIPTION OF THE PREFERRED EMBODIMENTS

In order to sense both very small (sub-mN) forces and a large range of forces, it is proposed to combine a flexible magnetic sensor and soft magnetized cilia. An embodiment consists of a flexible main body that embeds magnet(s), soft magnetized cilia attached to the main body, and magnetic sensing element(s) on a substrate layer. The sensing elements produce signals according to the magnetic-field created by the magnetic material in the sensor body. Consequently, the sensor generates signals when the sensor body interacts with foreign bodies that perturb the form and positions of the magnetic elements.

The term “cilia” is used herein to refer to soft elongate bodies, e.g. made of elastomers, preferably soft silicon. Cilia may have embedded magnets or magnetized powder. Preferably, the magnetized powder is evenly distributed in the soft body. Cilia cause changes in the magnetic field when they are deformed by external force. In embodiments, cilia are used to detect sub-mN forces and gain local surface information about interacting objects. The cilia count, sizes, topologies and locations may be varied for different applications. The shape and the material of a cilium may also vary. The magnet or the magnetized material in the cilium may be different in size and material components. Cilia may be cylindrical for ease of manufacture and to have an isotropic response. Although the term “cilia” is used in other contexts to mean “hair-like” it is not intended that the cilia of embodiments have dimensions similar to a hair.

In embodiments, the main body of the sensor consists of flexible material, preferably soft silicon, and a magnet embedded in the body. The body deforms as a reaction to external forces, and consequently the magnet is displaced. Hence, the magnetic field changes as a result of external forces. The main body can be used to detect a large range of forces. The relationship between the magnetic field and the external force depends on the properties of both the flexible body and the magnet. The elasticity, size and shape of the flexible material may be adjusted for different applications. Elasticity affects the sensitivity and the maximum force range of the sensor. Different shapes and sizes may be preferable according to the surface that the sensor is mounted on, the objects that the sensor interacts with, and the role of the sensor. As an example, the sensor may have the shape of a body part depending on its role. The size, location and material of the magnet may also vary to fit task requirements. The magnet is preferably permanent. The magnet is preferably centred above the sensing element, so that the magnetic field is symmetrical around its main axis.

The changes in the magnetic field are sensed using magnetic sensing element(s) on the substrate layer. A sensing element may be a Hall-effect sensor or a magnetoresistive sensor such as a GMR, for example. Preferably, the sensing element can sense three-axial changes in the magnetic field. The sensing element may be a combination of multiple magnetoresistive elements.

The sensor components can be miniaturized and distributed over a surface. There are commercially available magnets and Hall-effect sensor chips in mm scale. These can be arranged on a PCB to create a distributed tactile sensor with sub-cm spatial density. It is physically possible to manufacture even smaller magnets, cilia and Hall-effect sensor chips. The distributed sensor may be placed on a curved surface using a flexible PCB as the substrate layer. The PCB may also support other components such as digital to analog converters (if the magnetic sensing element(s) does not have a digital output) and communication components, e.g. a I2C or SMBus bus, or a multiplexor.

Soft bodies used in embodiments can be manufactured by either 3D printers or by molding and curing liquid elastomers. The magnets can be embedded into predetermined holes in the soft bodies. Alternatively, cilia can be manufactured by molding and curing a mixture of elastomer and magnetic particles, then magnetizing the particles under a magnetic field. Thus, the invention is suitable for mass production.

Embodiments can be used in various different tactile sensing applications. They May be attached to a robot to detect contacts and prevent heavy collisions. They can provide tactile feedback to improve robotic grasping quality and interaction safety. High sensitivity of cilia is beneficial in dealing with fragile or soft objects, such as a test tube or a strawberry. Embodiments may be used in various robotics applications such as agricultural, medical and manufacturing robotics to gain information about the properties of objects in the environment.

The distributed sensing capability is useful in classifying objects and understanding their surface characteristics. The invention may also be used in prostheses and wearable devices to provide feedback to the user. Other uses will occur to the skilled reader on reading of this description.

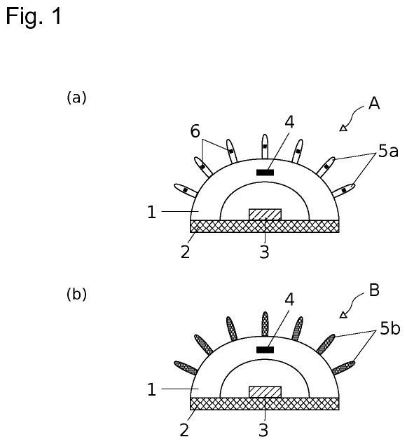

FIGS. 1(a) and (b) show schematically two semi-spherical tactile sensors A and B. In each of FIGS. 1(a) and (b), a cross-sectional side view of an embodiment is shown. These tactile sensors consist of a soft body 1 preferably in an approximately semi-spherical shape with a hollow centre, a substrate layer 2 on which the magnetic sensing element 3 and the soft body 1 are placed, a magnet 4 embedded in the soft body, and a multitude of soft cilia 5a, 5b attached to the soft body. These sensors differ by the types of cilia they contain. The cilia may be made of soft material with a magnet embedded inside 5a, or soft material with magnetized particles 5b, for example.

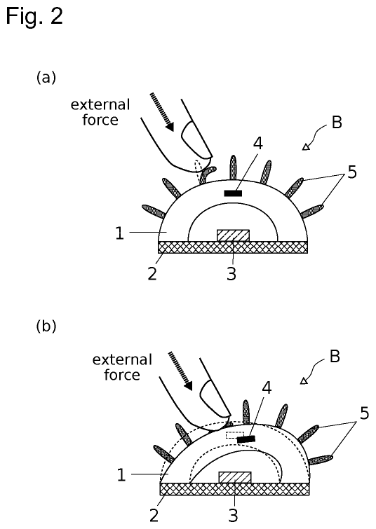

The behaviour of the tactile sensor B under external force is illustrated in FIGS. 2(a) and (b). Unperturbed forms of the components are shown by dashed lines. When a foreign body approaches the sensor, one or more of the cilia are contacted first, as shown in FIG. 2(a). A soft cilium is easily deformed by external force, and displaced magnetic material causes variation in the magnetic field. Consequently, the signal produced by the sensing element 3 changes. Since the cilia 5 are farther and magnetically weaker than the magnet 4 they create a small change in the magnetic field.

If the foreign body approaches the sensor further, it contacts the main body 1, as shown in FIG. 2(b). External force deforms the main body 1, the magnet 4 is displaced according to the magnitude and the direction of the external force, causing variation in the magnetic field. Consequently, the sensing element 3 produces a different signal. Movement of the main magnet 4 creates larger changes in the magnetic field than the movement of the cilia 5, as it is larger and closer to the sensing element.

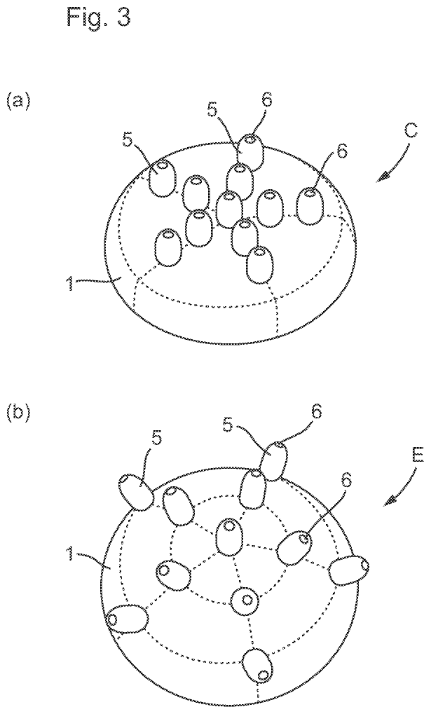

Perspective views of two semi-spherical embodiments C, E of the tactile sensor are shown in FIGS. 3(a) and (b). As depicted, there is a central cilium and two rings of 5 cilia arranged so that the cilia are aligned radially. More or fewer cilia can be provided, e.g. from 1 to 50 cilia per sensor. Other arrangements, e.g. with the cilia equally spaced, can be used. The cilia may be arranged irregularly. Sensor C has a flat top whilst sensor E has a convex top, e.g. dome-shaped.

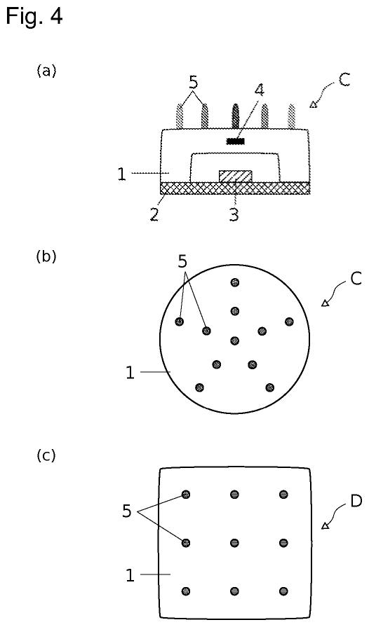

FIGS. 4(a) to (c) show schematically two flat embodiments of tactile sensors C and D. FIG. 4(a) shows a cross-section side view and FIG. 4(b) shows the top-down view of the flat embodiment C. The main body 1 has an approximately cylindrical shape with a hollow centre. Cilia 5 are only attached to the upper face of the main body that is expected to contact other objects. The cilia are arranged in a radial manner as shown in FIG. 3. In FIG. 4(c), a top-down view of an embodiment D with different cilia count and topology is presented. Sensor D has a rectangular prism shape, e.g. generally square, and nine cilia arranged in a 3×3 grid. Again, more or fewer cilia can be provided. Other arrangements, e.g. with the cilia equally spaced, can be used. The cilia may be arranged irregularly.

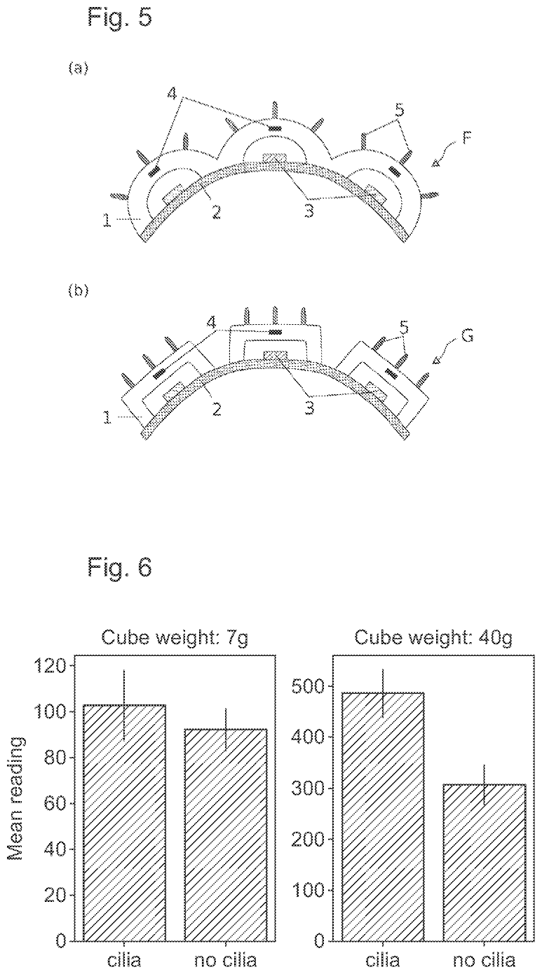

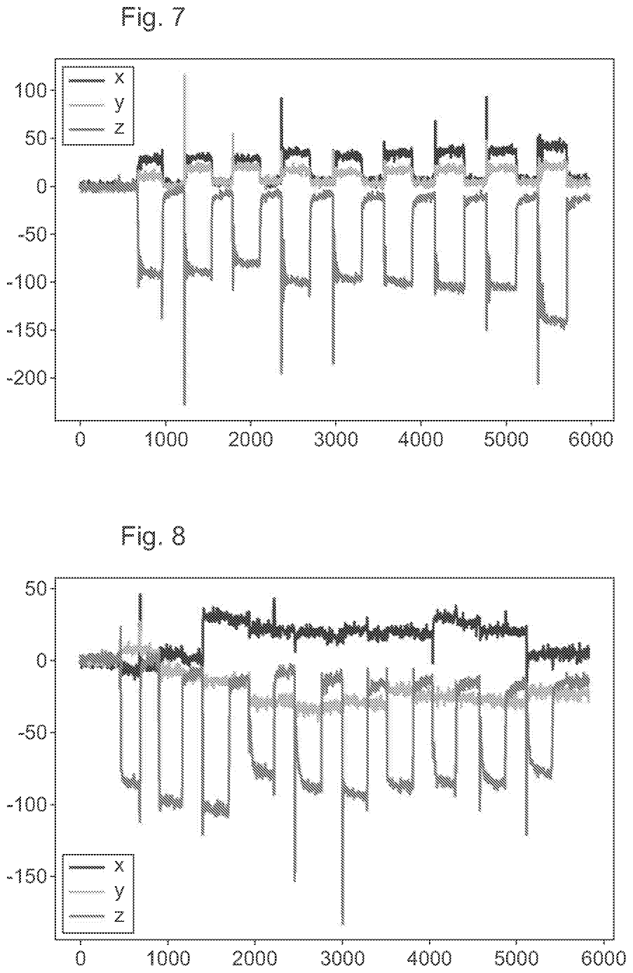

A distributed tactile sensor embodiment F is shown in FIG. 5(a). There are multiple sensing elements 3 on the curved substrate layer 2. There are multiple magnets 4 embedded in the soft body 1, and multiple cilia 5 distributed on the soft body 1. Each magnet and cilium is placed in the vicinity of a magnetic sensing element. There may be more cilia 5 than sensing elements 3. Desirably there is 1:1 relationship between magnets 4 and sensing elements 3. In another arrangement, the flexible body has the form of a sheet with the flexible projections on one side and magnets embedded therein. The sheet is spaced apart from the substrate on which the magnetic sensing elements are mounted. In a yet further arrangement, shown in FIG. 5(b), distributed tactile sensor G comprises a plurality of separate soft bodies 1 mounted to curved substrate 2 with spaces in between. As illustrated the soft bodies are flat topped with generally perpendicular side walls but any convenient shape can be used. The arrangement illustrated in FIG. 5(b) with separate projections may exhibit less cross-talk between sensing elements for better localisation of detection.

A prototype of the embodiment C was manufactured by molding and curing soft silicon (DragonSkin™). The mold contained a socket for the magnet in the main body and on the tips of the cilia 5. The prototype contained one magnet in the main body and 11 smaller magnets on the cilia. The substrate layer was a plastic box containing a Hall-effect sensor (MLX90393 by Melexis NV). We compared this prototype to the baseline sensor that is identical to the embodiment C, except that it does not have any cilia, i.e., it only has one magnet 4 in the main body. The sensitivities of both prototypes were tested by placing two different plastic cubes on the sensors. The cubes had different weights: 7 g and 40 g. A cube stayed for 2 seconds on the sensor, then the cube was left and the sensor rested for 2 seconds. This procedure was repeated 9 times for each sensor-cube pair. Then, two readings r_{cube}, rᵣₑₛₜ are sampled for each repetition, such that, r_{cube} is the reading 1 second after placing the cube and rᵣₑₛₜ is the reading when the sensor is at rest. A reading at time t is the 2-norm of the 3-dimensional x, y, z measurements:

$${r}_{i} ( t ) = \sqrt{{x ( t )}^{2} + {y ( t )}^{2} + {z ( t )}^{2}} , i ∈ \{ cube , rest \} \qquad ( 1 )$$

FIG. 8 shows the mean readings for each sensor-cube pair. The values are grounded, i.e., r_{grounded}=r_{cube}−rᵣₑₛₜ. The bars show the means of the 9 readings, and the thin lines are the standard deviations. The prototype with cilia produces higher values for each cube. We also see that the reading increases more for the sensor with cilia when we increase the cube weight. The mean ratios of the readings for the heavy and light cubes are 4.716 for the prototype with cilia and 3.334 for the baseline prototype. These observations show that the prototype with cilia has a higher sensitivity and it can detect smaller contact forces.

The x, y, z readings of the prototype with cilia during the sensitivity tests are shown in FIG. 9. The sensor reads residual forces x, y because the cilia are bent in these directions. The spikes in the readings are due to the instantaneous impact of placing a cube on the sensor. We ignore these spikes in our analysis by waiting for a second before sampling a reading. In some applications the spikes may provide useful information, e.g. as to timing of contact.

The x, y, z readings of the prototype without cilia during the sensitivity tests are shown in FIG. 10. The x, y readings are negligible because the force is applied alongside the gravity direction. The instantaneous spikes in the readings are ignored in our analysis, as described above.

It will be appreciated that the output of the magnetic sensing element(s) will need to be processed to obtain useful information. The exact form of that processing will depend on the specific application, the structure of the device and the information to be obtained. In general, smaller forces that affect only the cilia (flexible projections) will result in higher frequency outputs than larger processes affecting the flexible body.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below.

1. A force sensor comprising:
a magnetic sensing element;
a flexible body;
a magnet connected to the flexible body; and
a plurality of flexible projections having magnetic material embedded therein attached to the flexible body.

2. A force sensor according to claim 1 wherein the magnet is embedded in the flexible body.

3. A force sensor according to claim 1 wherein the magnet is a permanent magnet.

4. A force sensor according to claim 1 wherein the magnetic material comprises a magnetic body embedded in each flexible projection.

5. A force sensor according to claim 4 wherein the magnetic material is a magnetic powder dispersed in the flexible projections.

6. A force sensor according to claim 1 when the magnetic sensing element comprises a Hall-effect sensor or a magnetoresistive sensor.

7. A force sensor according to claim 1 further comprising a substrate to which the magnetic sensing element and the flexible body are mounted.

8. A force sensor according to claim 7 wherein the flexible body is configured so that there is a space between the flexible body and the magnetic sensing element.

9. A force sensor according to claim 8 wherein the flexible body has a dome-like shape.

10. A force sensor according to claim 8 wherein the flexible body has a generally flat outer surface.

11. A force sensor according to claim 1 wherein the ratio of flexible projections to magnetic sensors is in the range of 1:1 to 50:1.

12. A force sensor according to claim 1 wherein the flexible projections are substantially cylindrical.

13. A force sensor system comprising a plurality of force sensors according to claim 1 mounted to one substrate.

14. A force sensor system according to claim 13 where in the substrate is a flexible printed circuit board.
